(19) United States
(12) Patent Application Publication
(10) Pub. No.: US 2010/0051607 A1
(43) Pub. Date: Mar. 4, 2010

(54) High-Frequency Inductive Heating Apparatus and Pressure-Less Sintering Method Using the Same

(75) Inventors: Jae Ho Yang, Daejeon (KR); Jong Hun Kim, Daejeon (KR); Ki Won Kang, Daejeon (KR); Young Woo Rhee, Daejeon (KR); Keon Sik Kim, Daejeon (KR); Kun Woo Song, Daejeon (KR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignees: KOREA ATOMIC ENERGY RESEARCH INSTITUTE, Dajeon (KR); KOREA HYDRO & NUCLEAR POWER CO., LTD., Seoul (KR)

(21) Appl. No.: 12/405,008

(22) Filed: Mar. 16, 2009

(30) Foreign Application Priority Data
Aug. 27, 2008 (KR) 10-2008-0083919

(51) Int. Cl. H05B 6/00

(52) U.S. Cl. 219/618

(57) ABSTRACT

A high-frequency inductive heating apparatus of ceramic material, whereby the nonconductive ceramic specimen in which induced current is not generated at room temperature is rapidly heated in a preheating housing, and a pressure-less sintering method using the same, are disclosed. The high-frequency inductive heating apparatus includes a preheating housing placed in a chamber to preheat a ceramic material; an induction coil installed around the preheating housing for supplying induced current so that the preheating housing is heated; and a high-frequency current generator for supplying high-frequency current to the induction coil. According to the present invention, inductive heating is made possible of nonconductive ceramic material for which inductive heating has thus far been impossible because induced current is not generated at room temperature, so that rapid heating by the self-heating of the specimen of ceramic material is possible.

### CROSS REFERENCE TO RELATED APPLICATIONS

This application claims priority to Korean Patent Application No. KR 10-2008-0083919, filed on Aug. 27, 2008, the disclosure of which is incorporated herein by reference in its entirety.

### BACKGROUND OF THE INVENTION

1. Field of the Invention

The present invention relates to a high-frequency inductive heating apparatus and a pressure-less sintering method using the same, more specifically to a high-frequency inductive heating apparatus of ceramic material whereby the nonconductive ceramic specimen in which induced current is not generated at room temperature is rapidly heated in a preheating housing, and a pressure-less sintering method using the same.

2. Description of the Related Art

In general, ceramic material has a high melting point compared with metal material, is chemically stable, has various physicochemical characteristics, and is widely used as high-temperature material, structural material, functional material, etc. through a sintering process.

Such a ceramic sintering process consists of a step for preparing green pellets by compression molding of powder used as a starting material, and a step for heating the prepared green pellets to a temperature of about ⅔ that of the melting temperature thereof and maintaining at above temperature.

In the step for manufacturing the green pellets, additive powders or lubricants are added and mixed in order to improve the property of the sintered body such as sintered pellet density or grain size, or a preliminary molding step is further performed in order to improve the molding performance of the powder before molding.

As an apparatus for heating the prepared green pellet, an electric furnace is widely used. A large amount of heat is generated by a heating element provided inside of the electric furnace to uniformly heat the green pellet that is arranged in the electric furnace. At this time, the electric furnace is a heating apparatus for indirectly heating the green pellet at or below about 2000° C. by using a heating element provided inside it.

Since the green pellet is indirectly heated by the heating element of the electric furnace, the heating speed or heating temperature of the green pellet is varied with the characteristics of the heating element. For example, an general heating element has difficulty in heating up to high temperatures above 1800° C., and a metal heating element such as tungsten or a graphite heating element should be used in order to heat up to high temperatures above 1800° C. But these heating elements have a problem in that they should be in an inert atmosphere because they are oxidized during the heating process.

Another problem is that damage due to heat shock of the heating element should be considered, and the heating speed of the green pellet is limited because the heated portion is large due to the characteristics resulting from the indirect heating system.

A further problem is that the price of the electric furnace is high because a large quantity of refractory material is needed for heat insulation.

Because of these problems, it is required to develop a technology for the process of synthesizing or heating ceramic material by using a heating system other than the electric furnace. Especially in a case of manufacturing a sintered body by using a self-heating characteristic in which heat is generated in the material itself, there is an advantage that the process time can be reduced by increasing the heating speed, so interest in this is increasing steadily.

Heating apparatuses using the self-heating characteristics like above include a microwave sintering apparatus, spark plasma sintering apparatus and high-frequency inductive heating apparatus, etc.

Of these, the high-frequency inductive heating apparatus is used to heat a specimen positioned in an induction coil made of a copper, etc. When high-frequency alternating current is supplied to the induction coil, an electromagnetic field in which polarity in the induction coil is changed is formed, and an induced current is generated by the electromagnetic field on the surface of the specimen positioned in the center of the induction coil. Resistance heat is generated by electric resistance of the specimen itself, so the specimen is heated by the generated heat. At this time, in order for induced current to be generated on the surface of the specimen, the specimen should be conductive material or magnetic material, so that oxide-based ceramic material, which is a nonconductor at room temperature, is not heated by the high-frequency induction.

Therefore, the heating of the specimen using a high-frequency induction furnace up to now has been limited to metal, semiconductors or composite material containing metal, so the application is limited. In addition, a high-frequency inductive heating apparatus which can heat oxide-based ceramic material is not known in the prior art. In order to heat oxide-based ceramic material, an indirect heating method using graphite die, etc. is used as well. But such an indirect heating method still has a problem that ceramic material cannot be effectively heated up to above the temperature of the heating element.

That is, it is not possible to heat ceramic material above the temperature of the heating element by using the indirect heating method. Therefore, there is a troublesome process such as a pressing the sintered body in order to increase the density of it.

### SUMMARY OF THE INVENTION

Therefore, an object of the present invention is to provide a high-frequency inductive heating apparatus whereby ceramic material is preheated to make it self-heat and the temperature of ceramic material is raised for inductive heating.

Another object of the present invention is to provide a pressure-less sintering method whereby the ceramic sintered body is manufactured by using a high-frequency inductive heating apparatus having a preheating function.

In accordance with the present invention, there is provided a high-frequency inductive heating apparatus comprising: a preheating housing placed in a chamber to preheat a ceramic material; an induction coil installed around the preheating housing for supplying induced current so that said preheating housing is heated; and a high-frequency current generator for supplying high-frequency current to the induction coil.

In the present invention, the preheating housing may be placed inside of the induction coil.

In the present invention, the preheating housing may be made of material that can generate electric resistance heat by induced current at room temperature and can resist heat shock due to rapid heat change.

In the present invention, the preheating housing may be made of insulating material so as to prevent heat from being discharged out.

In the present invention, the preheating housing may be made of porous ceramic or graphite material containing metal grains.

In the present invention, the apparatus may further comprise a temperature sensor to detect a temperature of the ceramic material, and a control unit to control the output of the high-frequency current generator based on the temperature detected by the temperature sensor.

In the present invention, the ceramic material that is put in a crucible made of material such as alumina may be placed in the preheating housing.

In accordance with another aspect of the present invention, there is provided a pressure-less sintering method comprising the steps of: molding raw powder containing nonconductive ceramic powder to prepare a green pellet; placing the green pellet formed with the raw powder in a crucible and inserting the crucible containing the green pellet in a preheating housing; and applying induced current to the induction coil installed around the preheating housing so that the preheating housing is heated.

In the present invention, the green pellet may self-heat as induced current is generated directly through preheating, thereby the temperature of the green pellet reaches a predetermined temperature through self-heating.

In the present invention, the green pellet may be self-heated through preheating, so from the point of time when the temperature of the green pellet becomes higher than the temperature of the preheating housing, the temperature is maintained always above the temperature of the preheating housing.

In the present invention, the green pellet may include one or more nonconductive ceramic powders.

According to the high-frequency inductive heating apparatus of such a configuration and the pressure-less sintering method using the same, inductive heating is made possible of nonconductive ceramic material for which inductive heating has thus far been impossible because induced current is not generated at room temperature, so that rapid heating by the self-heating of the specimen of ceramic material is possible.

Also, according to the high-frequency inductive heating apparatus of such a configuration and the pressure-less sintering method using the same, it is possible to manufacture a ceramic sintered body having a high density within a short time of a few minutes without an additional pressing apparatus, since it utilizes the self-heating characteristic by the current induced to the ceramic material.

### BRIEF DESCRIPTION OF THE DRAWINGS

These and other objects, features, aspects, and advantages of the present invention will be more fully described in the following detailed description of preferred embodiments and examples, taken in conjunction with the accompanying drawings. In the drawings:

FIG. 1 is a schematic diagram showing the configuration of a high-frequency inductive heating apparatus of ceramic material according to the present invention;

FIG. 2 is a graph showing the characteristic that the ceramic material self-heats using the high-frequency inductive heating apparatus of ceramic material according to the present invention; and

FIG. 3 is a graph showing temperature variation with respect to the time of UO₂ sintered body, when the rate of temperature rising of ceramic material is varied by using the high-frequency inductive heating apparatus of ceramic material according to the present invention.

### DETAILED DESCRIPTION

The present invention will be more apparent from the following detailed description with accompanying drawings.

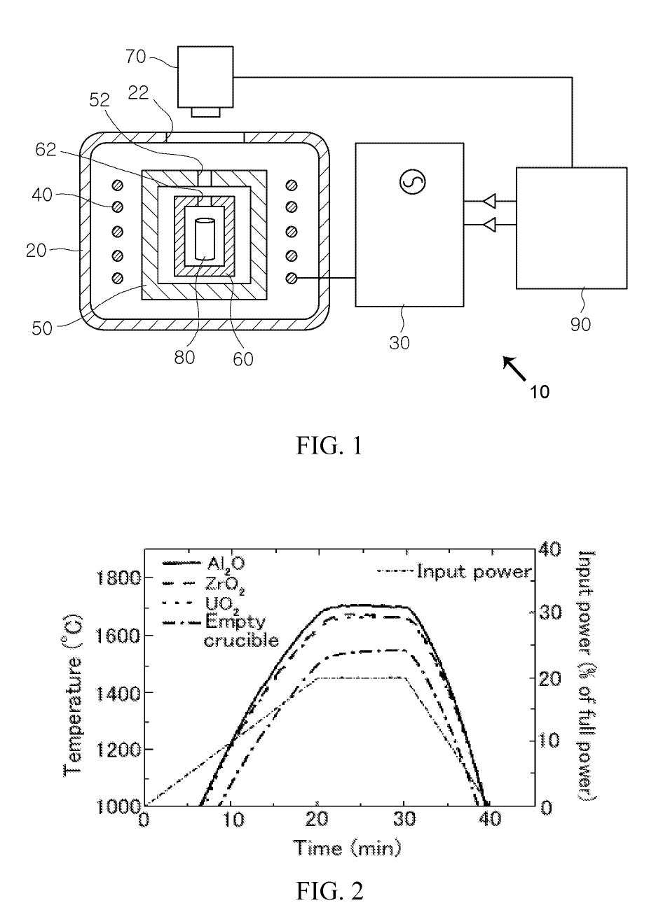

FIG. 1 is a schematic diagram showing the configuration of a high-frequency inductive heating apparatus of ceramic material according to the present invention.

Referring to FIG. 1, a high-frequency inductive heating apparatus 10 according to the present invention may comprise a preheating housing 50 placed in a chamber 20 to preheat a ceramic material 80, an induction coil 40 that supplies induced current to the preheating house 50 for heating, and a high-frequency current generator 30 that supplies high-frequency current to the induction coil 40.

The preheating housing 50 in the chamber 20 is installed inside of the induction coil 40, and is heated easily by induced current supplied from the induction coil 40. The induction coil 40 may be installed winding the outer circumference of the preheating housing 50.

The ceramic material 80 that is put in a crucible 60 is put inside of the preheating housing 50, and it is heated by operating the induction coil 40. Such a ceramic material 80 is an electric nonconductor because electric resistance is high at room temperature, but induced current is not generated on the surface of the specimen by high-frequency induction, so high-frequency inductive heating does not occur. However, if the temperature of the ceramic material 80 increases, the concentration and mobility of charged particles increase to make electric conductivity increase, so inductive heating becomes possible.

At this time, the inside of the chamber 20 can be made to be a vacuum by operating a vacuum pump to draw out air or can be filled with another gas.

The preheating housing 50 can generate electric resistance heat by induced current from the induction coil 40 at room temperature, can be made of material that can resist heat shock due to abrupt temperature change, and can be made of heat shield material so as to prevent heat from radiating out.

It is preferable that such a preheating housing is made of porous ceramic containing metal particles or graphite material.

The high-frequency current generator 30 generates high-frequency current of high output to make it flow in the induction coil 40, and its output is 1 to 100 kW. Preferably, the high-frequency current generator 30 is operated at a frequency not exceeding 100 MHz. The output is variable, and it is controlled by a programmed control unit 90.

Namely, the output of the high-frequency current generator 30 is controlled by a method whereby the temperature of the specimen of the ceramic material 80 placed in the preheating housing 50 is detected to maintain the temperature of the specimen at a predetermined temperature.

Therefore, the high-frequency inductive apparatus 10 further comprises a temperature sensor 70 that detects the temperature of the ceramic material 80 and sends it to the control unit 90. The control unit 90 can control the operation of the output of the high-frequency current generator 30 based on the temperature detected by the temperature sensor 70.

At this time, the temperature sensor 70 could be a noncontact infrared (IR) pyrometer as shown in FIG. 1, and in this case the sensor is installed outside of the chamber 20. Further, observation windows 22, 52 and 62 are installed in the chamber 20, the preheating housing 50 and the crucible 60 respectively to detect the temperature of the specimen of ceramic material 80.

The temperature sensor 70 can use a thermocouple thermometer, and it can be installed at the induction coil 40. In this case, temperature detecting errors due to induced current should be considered for accurate measurement.

To summarize the method of sintering without pressing the ceramic material by using such a high-frequency inductive heating apparatus 10: make a green pellet (specimen) of ceramic material by molding raw material powders containing nonconductive ceramic powders; put the green pellet in the crucible 60 and insert it into the preheating housing 50; and then preheat the preheating housing 50 by applying induced current to the induction coil 40 installed around the preheating housing 50.

The green pellet 80 can be molded by one or more nonconductive ceramic powders.

If the output of the high-frequency generator 30 is raised, current flows in the induction coil 40, and induced current is generated by this current in the preheating housing 50. Then, the preheating housing 50 is heated by electric resistance.

If the preheating housing 50 is preheated, the green pellet 80 inside thereof is self-heated, and induced current is generated directly through self-heating, so it reaches a predetermined temperature quickly.

Such a green pellet 80 is a specimen made of ceramic powders, so inductive heating does not occur at room temperature, but if temperature rises, electric resistance decreases, so induced current can be generated. If induced current is generated to make resistance heat, electric resistance is further lowered due to self-heating, and more induced current is generated to make the level of self-heating increase.

Such a rising action happens rapidly in a very short time to make the temperature of the green pellet 80 increase rapidly, and the green pellet 80 can be sintered very quickly.

The green pellet 80 generates heat by itself through preheating, so it is maintained at above the temperature of the preheating housing 50 at all times from the point of time when it is above the temperature of the preheating housing 50.

Below will be described experiments using the high-frequency heating apparatus of ceramic material and the pressure-less sintering method as described above to prove the reliability of high-frequency inductive heating and sintering of ceramic material of the present invention.

FIG. 2 is a graph showing the characteristic that the ceramic material self-heats using the high-frequency inductive heating apparatus of ceramic material according to the present invention.

In the experiment (below to be referred to as “Experimental Example 1”) to show the results of FIG. 2, 20 g of alumina (Al₂O₃) powder that is a nonconductor at room temperature was put in the alumina crucible 60 placed in a high-frequency heating apparatus 10, and temperature variation of alumina powder was detected at the time of high-frequency inductive heating. The high-frequency output was raised to 8 kW at a speed of 0.8 kW/min, and was decreased again after maintaining it for 10 minutes. Here, the preheating housing 50 was made of porous graphite composite material whose main component is graphite in which induced current can be generated at room temperature. A mixed gas of hydrogen and argon was continuously flowed in the chamber in order to prevent oxidation of graphite structure, and the temperature variation at the surface of the alumina powder contained in the crucible was detected using an IR pyrometer 70 while output was varied.

Also, the experiment was performed by substituting zirconia (ZrO₂) and urania (UO₂) powders other than the alumina powder as ceramic material, and in order to make comparison easy, the crucible was heated by the same method to detect temperature variation.

The high-frequency heating apparatus 10 is used according to the Experimental Example 1 for inductive heating of ceramic material to obtain the results of temperature variation according to the time of inductive heating and the output of the high-frequency generator, as shown in FIG. 2.

Namely, in the temperature variation curve, the temperature of the crucible containing the powder rose higher than the temperature of an empty crucible. This proves that additional self-heating occurred as induced current was generated also in the nonconductive ceramic specimen in which induced current is not generated at room temperature other than the heat generated in the preheating housing 50.

As a Comparative Example for this, an inductive heating experiment (below to be referred to as “Comparative Example 1”) was performed in the same process as Experimental Example 1 by using a preheating housing 50 of FIG. 1 that was made of heat shield material whose main component is alumina instead of graphite in which inductive heating occurs at room temperature.

In the case of Comparative Example 1, temperature measurement was impossible by an IR pyrometer which can sense temperatures of 1000° C. to 3000° C.

It should be considered that there was no heating of the ceramic material itself because the preheating housing 50 whose main component is alumina is not preheated so there was no temperature rise of ceramic material such as alumina inside it.

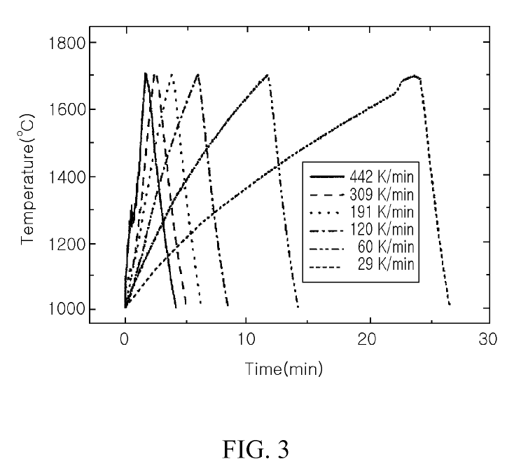

FIG. 3 is a graph showing temperature variation with respect to the time of UO₂ sintered body, when the rate of temperature rising of ceramic material is varied by using the high-frequency inductive heating apparatus of ceramic material according to the present invention, and table 1 shows the densities and sizes of crystal grains of UO₂ sintered bodies made according to FIG. 3.

TABLE 1
Densities and sizes of crystal grains of UO₂ sintered
bodies made according to FIG. 3.

| | Average Rate of | | | Crystal |
|---|---|---|---|---|
| Specimen | Temperature Increase | Density | Density | Grain Size |
| number | (K/min) | (g/cm³) | (% TD) | (μm) |
| Example 2-1 | 442 | 10.51 | 95.9 | 6.17 |
| Example 2-2 | 309 | 10.59 | 96.65 | 7.01 |
| Example 2-3 | 191 | 10.58 | 96.51 | 7.13 |
| Example 2-4 | 120 | 10.53 | 96.12 | 6.08 |
| Example 2-5 | 60 | 10.45 | 95.36 | 5.82 |
| Example 2-6 | 29 | 10.36 | 94.6 | 5.66 |

The experiment (below to be referred to as “Experimental Example 2”) for obtaining the results of FIG. 3 is an experiment in which ceramic specimens are rapidly heated to be sintered in the high-frequency heating apparatus 10 of FIG. 1. ADU-UO₂ powder was pressure formed to make a disk-shaped green pellet with a diameter of 10 mm and a height of 2.25 mm, and after placing this green pellet in the alumina crucible 60 of FIG. 1, the maximum output of the high-frequency generator was maintained at 7 kW. Subsequently, output was increased at a constant speed to heat the specimen. As soon as the specimen temperature reached 1700° C., the power of the high-frequency generator was turned off to cool the specimen to make a sintered body.

The resulting sintered body had its density measured by using Archimedes law, and after measuring the density the cross section of the sintered body was mirror polished to observe the porous structure. After that, heat etching was carried out to observe the crystal grain structure, and its size was detected by the linear intersection method.

Referring to the Experimental Example 2, it could be confirmed that the specimen whose output was increased most quickly according to the variation of output (average rate of temperature rising 442 K/min in a specimen of Example 2-1) was heated so rapidly that it took less than 100 seconds to heat from 1000° C. to 1700° C.

Table 1 shows the densities and sizes of crystal grains of Examples 2-2 to 2-6 according to the average rate of temperature rising, and in the case that ceramic material rose up to 1700° C., densities and sizes of crystal grains that are almost uniform in all embodiments could be obtained.

In particular, in the cases of Examples 2-1 to 2-4 which are experiment specimens having a total processing time of less than 10 minutes, it could be confirmed that sintered bodies having densities higher than 96% of the theoretical density can be obtained.

According to the high-frequency inductive heating apparatus of such a configuration and the pressure-less sintering method using the same, inductive heating is made possible of nonconductive ceramic material for which inductive heating has thus far been impossible because induced current is not generated at room temperature, so that rapid heating by the self-heating of the specimen of ceramic material is possible.

Also, according to the high-frequency inductive heating apparatus of such a configuration and the pressure-less sintering method using the same, it is possible to manufacture a ceramic sintered body having a high density within a short time of a few minutes without an additional pressing apparatus, since it utilizes the self-heating characteristic by the current induced to the ceramic material.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A high-frequency inductive heating apparatus, comprising:
a preheating housing, placed in a chamber, to preheat a ceramic material;
an induction coil, installed around said preheating housing, for supplying induced current so that said preheating housing is heated; and
a high-frequency current generator for supplying high-frequency current to said induction coil.

2. The apparatus according to claim 1, wherein said preheating housing is placed inside of said induction coil.

3. The apparatus according to claim 1, wherein said preheating housing is made of a material that can generate electric resistance heat by induced current at room temperature and can resist heat shock due to rapid heat change.

4. The apparatus according to claim 1, wherein said preheating housing is made of a material so as to prevent heat from being discharged therefrom.

5. The apparatus according to claim 3, wherein said preheating housing is made of porous ceramic or graphite material containing metal grains.

6. The apparatus according to claim 1, further comprising a temperature sensor to detect a temperature of said ceramic material, and a control unit to control an output of said high-frequency current generator based on the temperature detected by said temperature sensor.

7. The apparatus according to claim 1, wherein said ceramic material is placed in a crucible that is placed in said preheating housing.

8. A pressure-less sintering method, comprising:
molding raw powder, containing nonconductive ceramic powder, into a green pellet;
placing the green pellet, formed from said raw powder, in a crucible;
inserting the crucible containing the green pellet in a preheating housing; and
applying induced current to an induction coil, installed around said preheating housing, to heat said preheating housing.

9. The method according to claim 8, wherein said green pellet self-heats as induced current is generated directly through preheating, such that the temperature of the green pellet reaches a predetermined temperature through self-heating.

10. The method according to claim 8, wherein said green pellet is self-heated through preheating, and wherein, from the point of time when the temperature of the green pellet becomes higher than the temperature of the preheating housing, the temperature is maintained always above the temperature of the preheating housing.

11. The method according to claim 8, wherein said green pellet includes one or more nonconductive ceramic powders.
